(19) United States
(12) Patent Application Publication
(10) Pub. No.: US 2010/0316351 A1
(43) Pub. Date: Dec. 16, 2010

(54) SYSTEM AND METHOD FOR PROVIDING VIDEO FILE

(75) Inventor: Jong Sung ROH, Seoul (KR)

Correspondence Address: Jefferson IP Law, LLP, 1130 Connecticut Ave., NW, Suite 420, Washington, DC, 20036, US

(73) Assignee: SAMSUNG ELECTRONICS CO. LTD., Suwon-si (KR)

(21) Appl. No.: 12/786,831

(22) Filed: May 25, 2010

(30) Foreign Application Priority Data
Jun. 16, 2009 (KR) 10-2009-0053212

(51) Int. Cl. H04N 5/91

(52) U.S. Cl. 386/241; 386/E05.003; 386/351

(57) ABSTRACT

Provided is a method and system for providing a video file. The method includes registering, by a transmitter, a video content and a contents index indicating location information for a given section in the video content, transmitting, by the transmitter, the registered contents index to a receiver, when the registered video content is requested, and transmitting, by the transmitter, the requested video content to the receiver.

### PRIORITY

This application claims the benefit under 35 U.S.C. §119(a) of a Korean patent application filed on Jun. 16, 2009 in the Korean Intellectual Property Office and assigned Serial No. 10-2009-0053212, the entire disclosure of which is hereby incorporated by reference.

### BACKGROUND OF THE INVENTION

1. Field of the Invention

The present invention relates to a system and method for a broadcast service. More particularly, the present invention relates to a system and method for providing a video file as a broadcast service.

2. Description of the Related Art

In a modern information-oriented society, broadcast services are increasingly being provided as digital, multi-channel, broadband and high-quality services. Recently, as digital televisions, Portable Multimedia Players (PMPs) and portable broadcast devices have increased in popularity, new techniques for providing broadcast services are being considered. One of the broadcast services is a Video On Demand (VOD) service. Such a VOD service is not a one-way service where a video file is transmitted by a transmitter in one direction, but instead is a two-way service where a transmitter transmits a video file in response to a request of a receiver. That is, the receiver selectively downloads a video file, and plays the downloaded file. Here, while playing a video file, the receiver can control the video file by executing a trick mode, i.e., fast forwarding, fast reversing, slow forwarding, slow reversing, time searching, and the like.

However, in such a system for providing a video file, it is difficult for a receiver to play a video file or control a video file while downloading a video file. For example, in order to control a video file, the receiver needs to generate a video index, which indicates position information for each section in the video file before playing the video file. That is, when the download of a video file is complete, the receiver can generate a video index, play the video file, and control the video file using the video index. However, a relative time delay is generated in providing a video file because of such a process. Hence, there is a need to reduce the amount of time that is used in providing a video file.

### SUMMARY OF THE INVENTION

An aspect of the present invention is to address at least the above-mentioned problems and/or disadvantages and to provide at least the advantages described below. Accordingly, an aspect of the present invention is to provide a system and method for providing a video file as a broadcast service.

In accordance with an aspect of the present invention, a method of providing a video file is provided. The method includes registering, by a transmitter, a video content and a contents index indicating location information for a given section in the video content, transmitting, by the transmitter, the registered contents index to a receiver, when the registered video content is requested, and transmitting, by the transmitter, the requested video content to the receiver.

A method of providing a video file according to an aspect of the present invention further includes analyzing, by the receiver, the received contents index, when the registered contents index is received, and playing, by the receiver, the received video content using the analyzed contents index, during the reception of the requested video content, or when the reception of the requested video content reception is complete.

In accordance with another aspect of the present invention, a system for providing a video file is provided. The system includes a transmitter for registering a video content and a contents index indicating location information for a given section in the video content, for transmitting the registered contents index when the registered video content is requested, and for transmitting the requested video content, and a receiver for receiving the requested video content, and for playing the received video content.

The receiver analyzes the received contents index when the registered contents index is received, and plays the received video content by using the analyzed contents index, during the reception of the requested video content, or when the reception of requested video content reception is complete.

In accordance with still another aspect of the present invention, a method of being provided a video file is provided. The method includes requesting, by a receiver, a video content from a transmitter, receiving, by the receiver, a contents index corresponding to the requested video content, receiving, by the receiver, the requested video content, analyzing, by the receiver, the received contents index, when the registered contents index is received, and playing, by the receiver, the received video content using the analyzed contents index, during the reception of the requested video content, or when the reception of the requested video content reception is complete.

Hence, according to a system and method for providing a video file according to exemplary embodiments of the present invention, a transmitter provides a contents index, so that a receiver can play and control video contents from the video file. Moreover, the receiver can use the contents index without generating a contents index, so that the time needed for providing a video file, in a system for providing a video file, can be reduced.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will be more apparent from the following description taken in conjunction with the accompanying drawings, in which:

FIG. 1 illustrates a structure of a system for providing a video file according to an exemplary embodiment of the present invention;

FIG. 2 is a block diagram illustrating an internal configuration of a transmitter and a receiver in a system for providing a video file according to an exemplary embodiment of the present invention;

FIG. 3 is a flowchart illustrating a procedure for providing a video file according to an exemplary embodiment of the present invention;

FIG. 4 illustrates a video file according to an exemplary embodiment of the present invention;

FIG. 5 illustrates a procedure for providing a video file in a receiver according to an exemplary embodiment of the present invention;

FIG. 6 is a flowchart illustrating a procedure for providing a video file according to an exemplary embodiment of the present invention;

FIGS. 7(a) and 7(b) illustrate a video file according to an exemplary embodiment of the present invention; and

FIG. 8 is a flowchart illustrating a procedure for providing a video file in a receiver according to an exemplary embodiment of the present invention.

Throughout the drawings, it should be noted that like reference numbers are used to depict the same or similar elements, features, and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention are provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

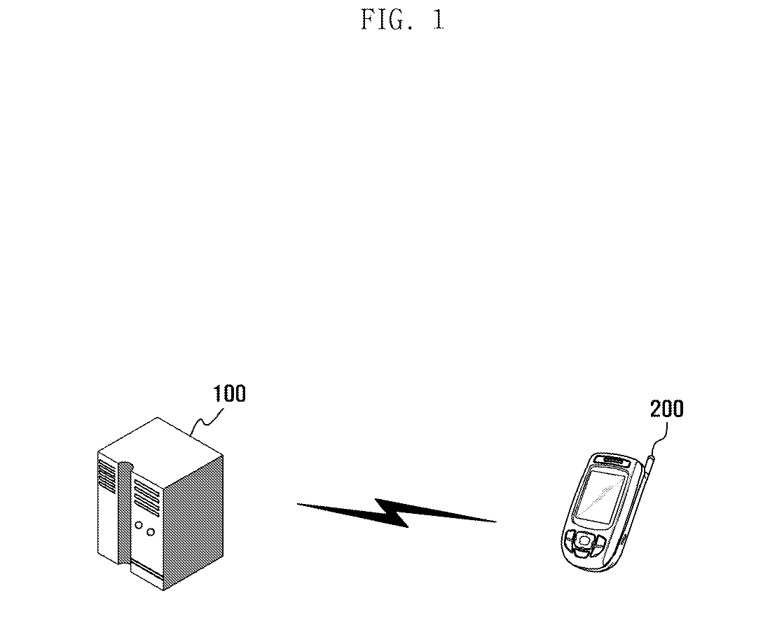

FIG. 1 illustrates a structure of a system for providing a video file according to an exemplary embodiment of the present invention.

Referring to FIG. 1, a system for providing a video file according to an exemplary embodiment of the present invention comprises a transmitter for transmitting a video file and a receiver for receiving and playing a video file. At this time, in the present example, it is assumed that the transmitter is a server 100, and the receiver is a client 200.

The server 100 registers several video files. Here, the video files include video contents consisting of video data, audio data, and the like. At this time, the server 100 registers a contents index which represents position information for each section in each video file. In addition, if a certain video file is requested, the server 100 transmits the contents index of the corresponding video file and the video file.

The client 200 can request a certain video file from the server 100. In addition, if the client 200 receives a contents index and a video file transmitted from the server 100, the client 200 plays the video file using the contents index. That is, the client 200 plays the video file while receiving the video file. In addition, the client 200 can control the video file by executing a trick mode while playing the video file.

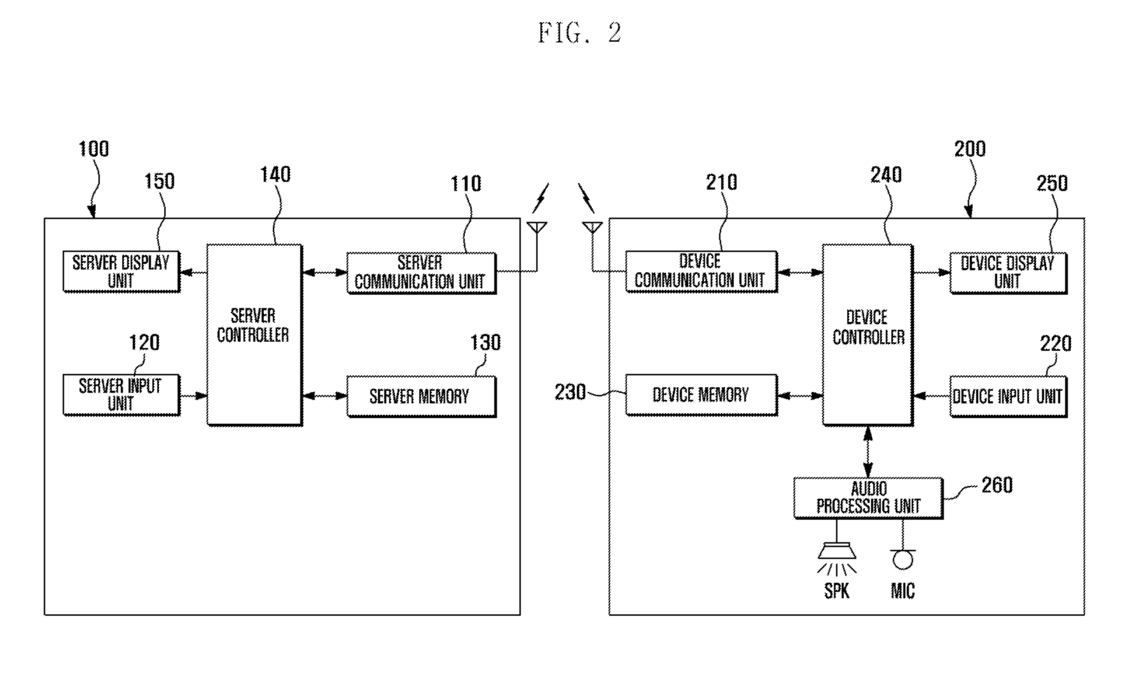

FIG. 2 is a block diagram illustrating an internal configuration of a transmitter and a receiver in a system for providing a video file according to an exemplary embodiment of the present invention.

A server 100 comprises a server communication unit 110, a server input unit 120, a server memory 130, a server controller 140 and a server display unit 150.

The server communication unit 110 performs a wireless communication function of the server 100. Such a server communication unit 110 includes a Radio Frequency (RF) transmitter (not shown) which up-converts and amplifies the frequency of a transmitted signal, and an RF receiver (not shown) which low-noise-amplifies a received signal and down-converts the frequency.

The server input unit 120 inputs number and character information, and sets various functions.

The server memory 130 may include a program memory (not shown) and a data memory (not shown). The program memory stores programs for controlling general operations of the server 100. At this time, the program memory stores programs for registering and transmitting a video file according to an exemplary embodiment of the present invention. The data memory stores data which is generated while programs are executed. Such a server memory 130 stores several video files according to an exemplary embodiment of the present invention. In addition, the server memory stores a contents index which represents position information for each regular section in each video file according to an exemplary embodiment of the present invention. At this time, the server memory 130 matches a contents index with each video file, and stores the match information.

The server controller 140 controls general operations of the server 100. Such a server controller 140 includes a data processing unit (not shown) which encodes and modulates a signal to be transmitted and demodulates and decodes a received signal. At this time, the data processing unit may include a modem (not shown) and a CODer-DECoder (CODEC) (not shown). In addition, the server controller 140 registers a video file according to an exemplary embodiment of the present invention. At this time, the server controller 140 registers a contents index of the video file according to an exemplary embodiment of the present invention. In addition, the server controller 140 controls such that the video file is transmitted to the client 200 in response to the request of the client 200.

The server display unit 150 displays user data which is output from the server controller 140. Such a server display unit 150 may use a Liquid Crystal Display (LCD) (not shown), and, in such a case, the server display unit 150 may include an LCD controller (not shown), a memory (not shown) that can store video data, and an LCD display device (not shown). At this time, if the LCD is implemented as a touch screen, the LCD may also be an input unit.

Further, the client 200 includes a device communication unit 210, a device input unit 220, a device memory 230, a device controller 240, a device display unit 250 and an audio processing unit 260.

The device communication unit 210 performs a wireless communication function of the client 200. Such a device communication unit 210 includes an RF transmitter (not shown) which up-converts and amplifies the frequency of a transmitted signal and an RF receiver (not shown) which low-noise-amplifies a received signal and down-converts the frequency.

The device input unit 220 inputs number and character information and sets various functions.

The device memory 230 may include a program memory (not shown) and a data memory (not shown). The program memory stores programs for controlling general operations of the client 200. At this time, the program memory stores programs for receiving and playing a video file according to an exemplary embodiment of the present invention. The data memory stores data which is generated while programs are executed.

The device controller 240 controls general operations of the client 200. Such a device controller 240 includes a data processing unit (not shown) which encodes and modulates a signal to be transmitted and a receiver (not shown) which demodulates and decodes a received signal. At this time, the data processing unit may include a modem (not shown) and a CODEC (not shown). In addition, the device controller 240 requests a desired video file from the server 100 according to an exemplary embodiment of the present invention. In addition, the device controller 240 receives and analyzes the contents index of the desired video file according to an exemplary embodiment of the present invention. In addition, the device controller plays a video file using the contents index while the video file is received according to an exemplary embodiment of the present invention.

The device display unit 250 displays user data which is output from the device controller 240. Such a device display unit 250 may use an LCD (not shown), and, in such a case, the server display unit 150 may include an LCD controller (not shown), a memory (not shown) that can store video data, and an LCD display device (not shown). At this time, if the LCD is implemented as a touch screen, the LCD may also operate as an input unit. In addition, the device display unit 250 outputs video data from video contents of the video file while the video file is played according to an exemplary embodiment of the present invention.

The audio processing unit 260 plays reception audio data output from the audio CODEC of the data processing unit through a speaker (SPK), or transmits audio data generated from a microphone (MIC) to the audio CODEC of the data processing unit. In addition, the audio processing unit outputs audio data from video contents of the video file while the video file is played according to an exemplary embodiment of the present invention.

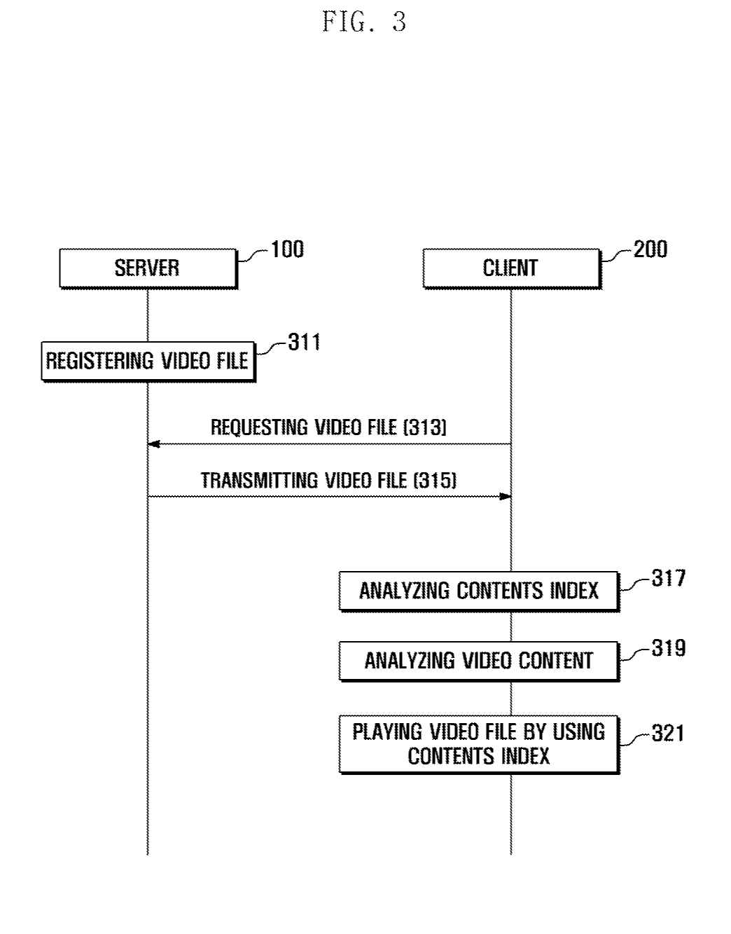

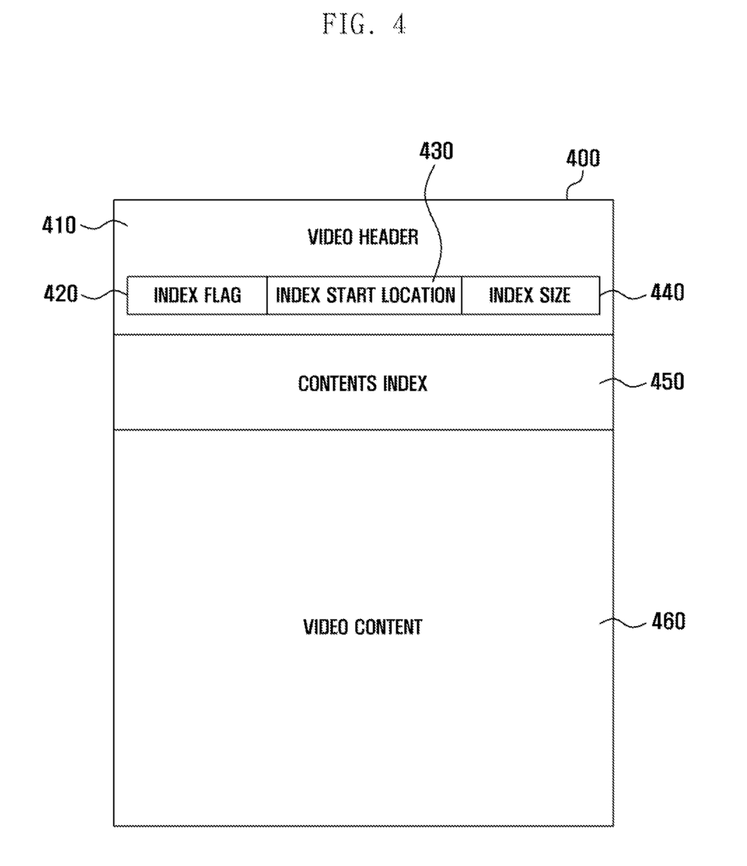

FIG. 3 is a flowchart illustrating a procedure for providing a video file according to an exemplary embodiment of the present invention. FIG. 4 illustrates a video file according to an exemplary embodiment of the present invention.

Referring to FIG. 3, in the video file providing procedure of the exemplary embodiment, the server controller 140 begins to register a video file 400, as shown in FIG. 4, in step 311. At this time, the server controller 140 inserts a contents index 450 into the video file 400 and stores it in the server memory 130. That is, the video file 400 is comprised of a video header 410, the contents index 450 and a video content 460. Here, the video header 410 includes at least one of an index flag 420 for indicating whether the contents index 450 is inserted into the video file 400, an index start location 430 of the contents index 450 in the video file 400, and an index size 440 of the contents index 450. If the video file 400 is requested from the client 200 in step 313, the server controller 140 transmits the video file 400 to the client 200 in step 315.

After requesting the video file 400 from the server 100 at step 313, if the video file 400 is received from the server 100 at step 315, the device controller 240 analyzes a contents index 450 in step 317. The device controller 240 analyzes the video content 460 in step 319. During the reception of video file 400, the device controller 240 plays the video file 400 by using the contents index 450 in step 321. At this time, the device controller 240 substantially plays the video content 460.

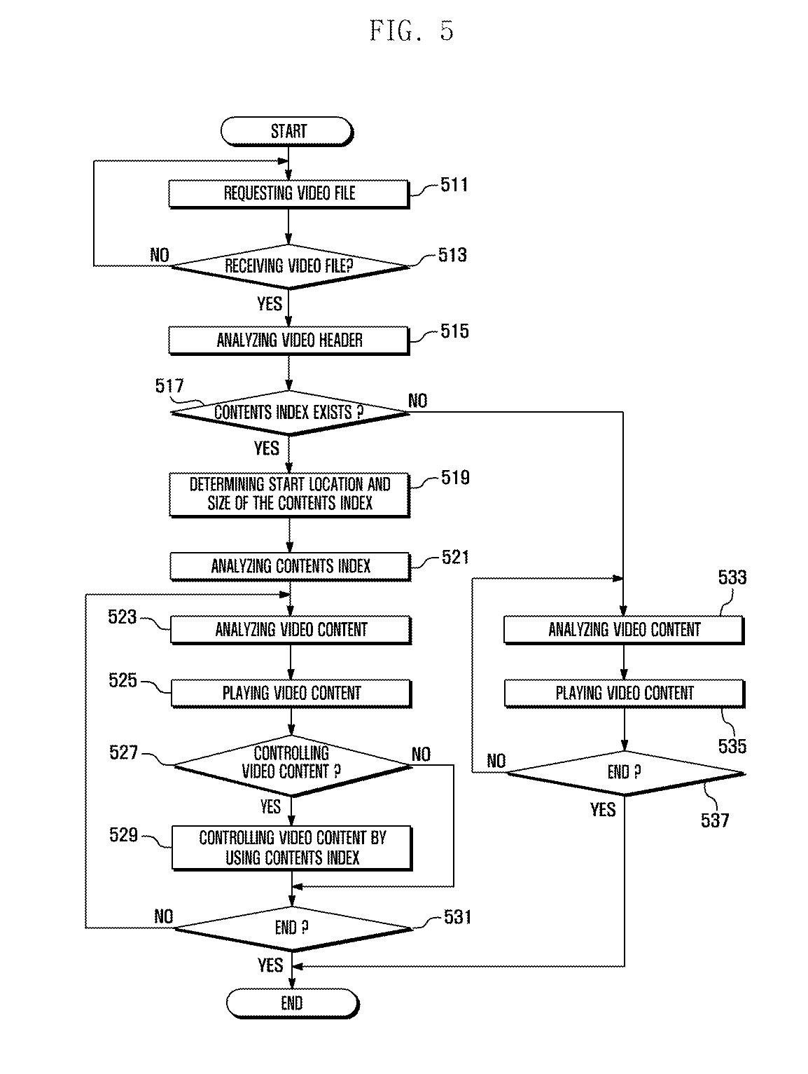

FIG. 5 is a flowchart illustrating a procedure for providing a video file in a receiver according to an exemplary embodiment of the present invention.

Referring to FIG. 5, in the present exemplary embodiment, in the video file providing procedure of the client 200, the device controller 240 requests the video file 400 from the server 100 in step 511. When the server 100 begins to receive the video file 400, the device controller 240 detects this in step 513, and analyzes the video header 410 in step 515. The device controller 240 determines whether the contents index 450 exists in the video file 400 through the index flag 420 of the video header 410 in step 517.

If it is determined that the contents index 450 exists in the video file 400 at step 517, the device controller 240 checks the index start location 430 and index size 440 of the contents index 450 in the video header 410 in step 519. The device controller 240 analyzes the contents index 450 according to the index start location 430 and index size 440 of the contents index 450 in step 521. That is, the device controller 240 analyzes an area corresponding to the index size 440 from the index start location 430 in the video file 400, and obtains the contents index 450. Then, during the reception of video file 400, the device controller 240 analyzes the video content 460 in step 523. At this time, the device controller 240 analyzes the video content 460 which has been received up to the present point in time for the video file 400. And during the reception of the video file 400, the device controller 240 plays the video content 460 in step 525. At this time, the device controller 240 plays the video content 460 which has been analyzed up to the present point in time for the video file 400. If the control of the video content 460 is requested during the playing of the video content 460 at step 525, the device controller 240 detects this in step 527, and controls the video content 460 by using the contents index 450 in step 529. At this time, the device controller 240 may perform the trick mode, i.e., fast forwarding, fast reversing, slow forwarding, slow reversing, and time searching to control the video content 460.

For instance, the device controller 240 can move the video content 460 to another section which is spaced with a certain gap from the present section in the video content 460 according to the contents index 450. Here, the device controller 240 is able to control the video content 460 which has been analyzed up to the present point in time for the video file 400.

Finally, if the termination of the video file 400 providing procedure is requested, the device controller 240 detects this in step 531, and terminates the video file 400 providing procedure. That is, until the request for terminating the video file 400 providing procedure is generated, the device controller 240 repeatedly performs step 523 to step 531. In other words, at step 525 or 529, if the request for terminating the video file 400 providing procedure is generated during the playing of the video content 460, the device controller 240 can terminate the video file 400 providing procedure.

In the meantime, if it is determined that the contents index 450 does not exist in the video file 400 at step 517, the device controller 240 analyzes the video content 460 in step 533. At this time, the device controller 240 analyzes the video content 460 which has been received up to the present point in time for the video file 400. And the device controller 240 plays the video content 460 in step 535. At this time, the device controller 240 plays the video content 460 which has been analyzed up to the present point in time for the video file 400. If the request for terminating the video file 400 providing procedure is generated, the device controller 240 detects this in step 537, and terminates the video file 400 providing procedure. That is, until the request for terminating the video file 400 providing procedure is generated, the device controller 240 repeatedly performs steps 533 to 537.

In the meantime, in the above-described exemplary embodiment, it was disclosed that a video file to which the contents index is inserted is provided, but it is not limited to this. That is, it possible to implement the exemplary embodiments of the present invention by providing the contents index with a separate file which is not a video file. However, the contents index has to be provided before the video file, which is illustrated in more detail below.

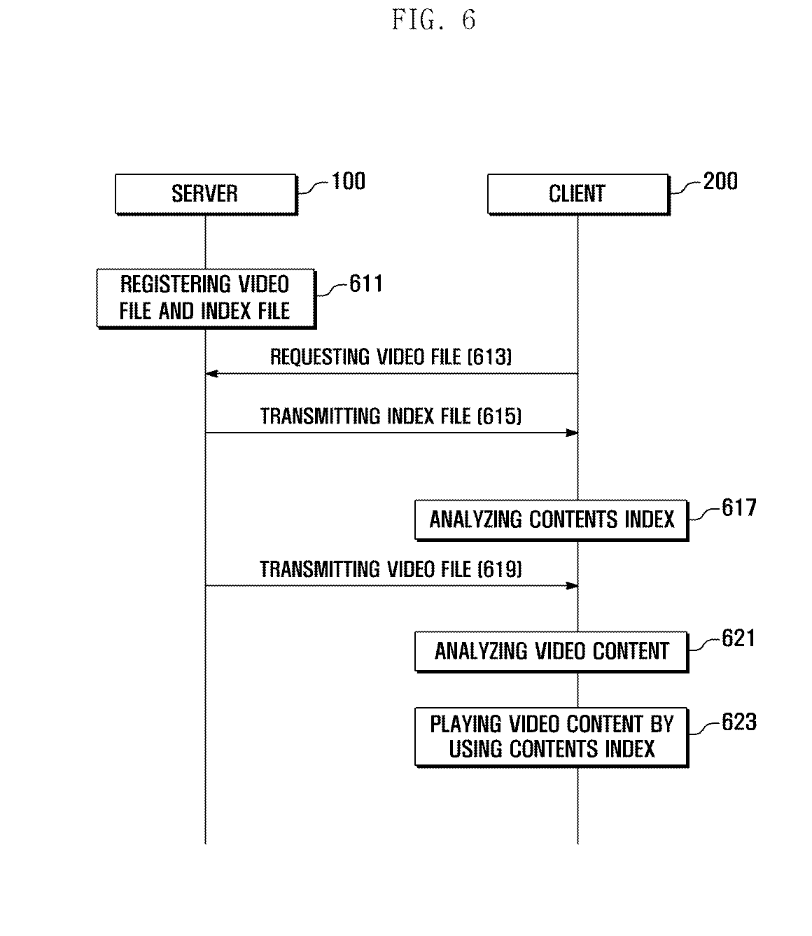

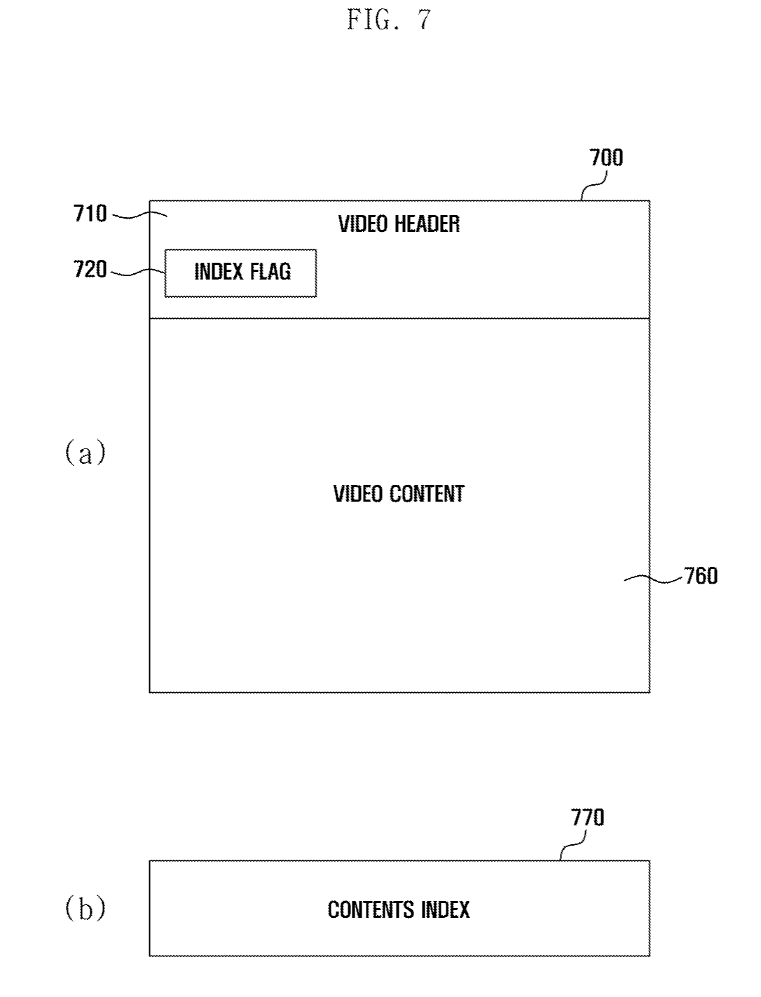

FIG. 6 is a flowchart illustrating a procedure for providing a video file according to an exemplary embodiment of the present invention. FIGS. 7(a) and 7(b) illustrate a video file according to an exemplary embodiment of the present invention.

Referring to FIG. 6, in the video file providing procedure of an exemplary embodiment of the present embodiment, the server controller 140 begins to register a video file 700, as shown in FIG. 7(a), in step 611. At this time, the server controller 140 stores the video file 700 in the server memory 130. That is, the video file 700 is comprised of a video header 710 and a video content 760. Here, the video header 710 includes an index flag 720 for indicating whether the contents index of the video file 700 exists. The server controller 140 stores the index file 770 illustrated in FIG. 7(b) in the server memory 130. That is, the index file 770 includes the contents index. In other words, the server controller 140 stores the contents index within the index file 770 separate from the video file 700.

Here, the server controller 140 matches the index file 770 to a corresponding video file 700 and registers it. If the video file 700 is requested from the client 200 in step 613, the server controller 140 transmits the index file 770 in step 615, and transmits the video file 700 to the client 200 in step 619.

If the index file 770 is received from the server 100 at step 615 after the video file 700 is requested from the server 100 at step 613, the device controller 240 analyzes the contents index of the index file 770 in step 615. If the video file 700 is received from the server 100 at step 619, the device controller 240 analyzes the video content 760 in step 621. During the reception of video file 700, the device controller 240 plays the video file 700 by using the contents index of the index file 770 in sep 623. At this time, the device controller 240 substantially plays the video content 760.

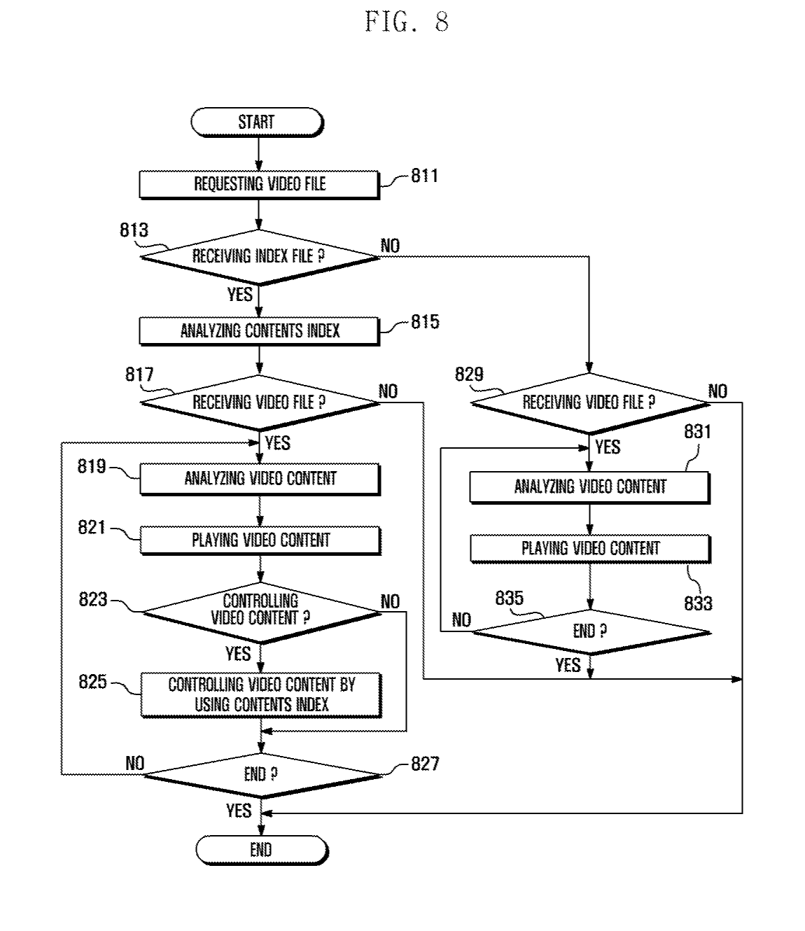

FIG. 8 is a flowchart illustrating a procedure for providing a video file in a receiver according to an exemplary embodiment of the present invention.

Referring to FIG. 8, in the present exemplary embodiment, in the video file providing procedure of the client 200, the device controller 240 begins to request the video file 400 from the server 100 in step 811. If the server 100 receives the index file 770, the device controller 240 detects this in step 813, and analyzes the contents index of the index file 770 in step 815. If the server 100 receives the video file 700 from the video header 710, the device controller 240 detects this in step 817, and analyzes the video file 700 in step 819.

At this time, the device controller 240 analyzes the video header 710 from the video file 700, and can determine whether the contents index of a corresponding video file 700 exists through the index flag 720. The device controller 240 analyzes the video content 760 which has been received from the video file 700 up to the present point in time. Moreover, during the reception of video file 700, the device controller 240 plays the video content 760 in step 821. At this time, the device controller 240 plays the video content 760 which has been analyzed in the video file 700 up to the present point in time.

If the control of the video content 760 is requested during the playing of the video content 760 at step 821, the device controller 240 detects this in step 823, and controls the video content 760 by using the contents index of the index file 770 in step 825.

At this time, if it is determined that the contents index exists through the index flag 720, the device controller 240 controls the video content 760 by using the contents index. That is, the device controller 240 performs the trick mode, so that it can control the video content 760 by fast forwarding, fast reversing, slow forwarding, slow reversing, and time searching. For example, the device controller 240 can move to another section which is spaced with a certain gap from the present section in the video content 760 according to the contents index, and play the video content 760. Here, the device controller 240 is able to control the video file 700 within the video content 760 which has been analyzed up to the present point in time. But if it is determined that the contents index does not exist through the index flag 720, the device controller 240 ignores the control request of the video content 760. Finally, if the request for terminating the video file 700 providing procedure is generated, the device controller 240 detects this in step 827, and terminates the video file 700 providing procedure. That is, until the request for terminating the video file 700 providing procedure is generated, the device controller 240 repeatedly performs steps 819 to 827.

In other words, if the request for terminating the video file 700 providing procedure is generated during the playing of the video content 760 at step 821 or 825, the device controller 240 can terminate the video file 700 providing procedure. In the meantime, if the server 100 does not receive the index file 770, but begins to receive the video file 700 from the video header 710, the device controller 240 detects this in step 829, and analyzes the video content 760 in step 831.

At this time, the device controller 240 analyzes the video content 760 which has been received up to the present point in time for the video file 700. During the reception of video file 700, the device controller 240 plays the video content 760 in step 833. At this time, the device controller 240 plays the video content 760 which has been analyzed up to the present point in time of the video file 700. If the request for terminating the video file 700 providing procedure is generated, the device controller 240 detects this in step 835, and terminates the video file 700 providing procedure. That is, until the request for terminating the video file 700 providing procedure is generated, the device controller 240 repeatedly performs steps 831 to 835.

In the video file providing system and method, the transmitter provides a contents index, so that the receiver can play and control video content in a video file. Additionally, the contents index can be used without generating contents index by receiver. Accordingly, the time needed for providing the video file in the video file providing system can be reduced.

While the invention has been shown and described with reference to certain exemplary embodiments thereof, it will be understood by those skilled in the art that various changes in form and details may be made therein without departing from the spirit and scope of the invention as defined in the appended claims and their equivalents.

What is claimed is:

1. A method of providing a video file, the method comprising:
registering, by a transmitter, a video content and a contents index indicating location information for a given section in the video content;
transmitting, by the transmitter, the registered contents index to a receiver, when the registered video content is requested; and
transmitting, by the transmitter, the requested video content to the receiver.

2. The method of claim 1, further comprising:
analyzing, by the receiver, the received contents index, when the registered contents index is received; and
playing, by the receiver, the received video content using the analyzed contents index, during the reception of the requested video content, or when the reception of the requested video content reception is complete.

3. The method of claim 2, wherein the playing of the received video content using the analyzed contents index comprises implementing a trick mode using the analyzed contents index so that the video content is one of fast forwarded, fast reversed, slow forwarded, slow reversed, and time searched.

4. The method of claim 1, further comprising:
generating a video file comprising a video header indicating at least one of whether the contents index exists, the contents index, and the video content.

5. The method of claim 4, wherein the video header further comprises a location of the contents index in the video file, and
wherein the analyzing of the received contents index comprises:
analyzing, by the receiver, the video header and determining the location of the registered contents index; and
analyzing, by the receiver, the registered contents index in the determined location.

6. The method of claim 5, wherein the video header comprises at least one of an index flag indicating whether the contents index is inserted in the video file, a start location of the contents index, and a size of the contents index.

7. The method of claim 1, wherein registered contents index and the requested video content are both included in a video file that is transmitted to the receiver.

8. The method of claim 1, wherein registered contents index and the requested video content are separately transmitted to the receiver, and wherein the registered contents index is transmitted to the receiver before requested video content is transmitted to the receiver.

9. A system for providing a video file, the system comprising:
a transmitter for registering a video content and a contents index indicating location information for a given section in the video content, for transmitting the registered contents index when the registered video content is requested, and for transmitting the requested video content; and
a receiver for receiving the requested video content, and for playing the received video content.

10. The system of claim 9, wherein the receiver analyzes the received contents index when the registered contents index is received, and plays the received video content by using the analyzed contents index, during the reception of the requested video content, or when the reception of requested video content reception is complete.

11. The system of claim 10, wherein the playing of the received video content using the analyzed contents index comprises implementing a trick mode using the analyzed contents index so that the video content is one of fast forwarded, fast reversed, slow forwarded, slow reversed, and time searched.

12. The system of claim 9, wherein the transmitter generates a video file comprising a video header indicating at least one of whether the contents index exists, the contents index, and the video content.

13. The system of claim 12, wherein the video header further comprises a location of the contents index in the video file, and the receiver analyzes the video header and determines the location of the registered contents index, and analyzes the registered contents index in the determined location.

14. The system of claim 13, wherein the video header comprises at least one of an index flag indicating whether the contents index is inserted in the video file, a start location of the contents index, and a size of the contents index.

15. The system of claim 9, wherein registered contents index and the requested video content are both included in a video file that is transmitted to the receiver.

16. The system of claim 9, wherein registered contents index and the requested video content are separately transmitted to the receiver, and wherein the registered contents index is transmitted to the receiver before requested video content is transmitted to the receiver.

17. A method of being provided a video file, the method comprising:
requesting, by a receiver, a video content from a transmitter;
receiving, by the receiver, a contents index corresponding to the requested video content;
receiving, by the receiver, the requested video content;
analyzing, by the receiver, the received contents index, when the registered contents index is received; and
playing, by the receiver, the received video content using the analyzed contents index, during the reception of the requested video content, or when the reception of the requested video content reception is complete.

18. The method of claim 17, wherein the playing of the received video content using the analyzed contents index comprises implementing a trick mode using the analyzed contents index so that the video content is one of fast forwarded, fast reversed, slow forwarded, slow reversed, and time searched.

19. The method of claim 17, wherein registered contents index and the requested video content are both included in a video file that is transmitted to the receiver.

20. The method of claim 19, wherein the video file comprises a video header indicating at least one of whether the contents index exists, the contents index, the video content, and the location of the contents index in the video file, and
wherein the analyzing of the received contents index comprises:
analyzing, by the receiver, the video header and determining the location of the registered contents index; and
analyzing, by the receiver, the registered contents index in the determined location.

21. The method of claim 17, wherein registered contents index and the requested video content are separately transmitted to the receiver, and wherein the registered contents index is transmitted to the receiver before requested video content is transmitted to the receiver.
